(19) United States
(12) Patent Application Publication
(10) Pub. No.: US 2013/0182174 A1
(43) Pub. Date: Jul. 18, 2013

(54) RETRACTABLE LENS BARREL AND IMAGING APPARATUS

(71) Applicant: TAMRON CO., LTD., Saitama-shi (JP)

(72) Inventors: Yasuhiro HATAKEYAMA, Saitama-shi (JP); Suyuan TAN, Saitama-shi (JP)

(73) Assignee: TAMRON CO., LTD., Saitama-shi (JP)

(21) Appl. No.: 13/712,468

(22) Filed: Dec. 12, 2012

(30) Foreign Application Priority Data
Jan. 18, 2012 (JP) 2012-008536

(51) Int. Cl. G02B 7/02

(52) U.S. Cl. CPC G02B 7/021
USPC 348/360; 359/813

(57) ABSTRACT

In an imaging apparatus, during an utilization state, optical elements and an image sensor are arranged on the same optical axis. During a retracted state, the optical elements in include at least one optical element that is moved from an optical axis position on the optical axis to a first retraction position that differs from the optical axis position; the image sensor is moved from the optical axis position to a second retraction position that differs from the first retraction position; and the moved optical element and the image sensor are arranged such that at least one portion of the move optical element and of the image sensor overlap in a plane substantially orthogonal to the optical axis.

### BACKGROUND OF THE INVENTION

1. Field of the Invention

The present invention relates to a retractable lens barrel that is extended in use and is retracted not in use, and an imaging apparatus equipped with the retractable lens barrel.

2. Description of the Related Art

Retractable lens barrels that are extended along a direction parallel to the optical axis when in use and retracted when not in use as well as imaging apparatuses equipped with such retractable lens barrels are known. Among such conventional retractable lens barrels and imaging apparatuses is a technology in which optical elements of the lens are moved from positions on the optical axis during a retracted state, whereby a dimension parallel to the optical axis can be reduced.

Conventionally, for example, a technology exists in which the imaging optical axis and the central axis of the lens barrel are eccentric, where in a retracted state, a first lens group and a second lens group are moved toward a CCD that is away from the imaging optical axis and in an imaging state, the lens barrel extends and rotates about the central axis of the lens barrel, aligning the optical axes of the first lens group and the second lens group along with the imaging optical axis (for example, refer to Japanese Patent Application Laid-Open Publication No. 2005-326627).

Further, for example, a conventional technology exists in which a zoom lens group and a focusing lens group included in a first lens system are coupled to the rotation of a rotating cylinder and are moved to a space off of the optical axis (for example, refer to Japanese Patent No. 4645105).

Nonetheless, conventional technologies including those in Japanese Patent Application Laid-Open Publication No. 2005-326627 and Japanese Patent No. 4645105 have a problem in that in the retracted state, after retracting optical elements have been moved from a position for use to a position for retraction, non-retracting optical elements adjacent to those that are retracted are moved to a space resulting from the retraction of the retracting optical elements. Therefore, in order to prevent interference between the retracting optical elements and the non-retracting optical elements, the outer diameter of the retractable lens barrel is increased and consequently, the size during non-use is not sufficiently reduced.

Further, to maintain a small outer diameter of the retractable lens barrel, the outer diameter of the retracting optical elements or that of the non-retracting optical elements has to be as small as possible, reducing the degree of freedom in the design of the optical elements.

### SUMMARY OF THE INVENTION

It is an object of the present invention to at least solve the above problems in the conventional technologies.

A retractable lens barrel includes multiple optical elements, is extended in a utilization state, and retracted along a direction parallel to an optical axis in a retracted state. The optical elements, in the utilization state, are arranged adjacently on the same optical axis and include a first optical element and a second optical element that can be moved relative to one another along a direction parallel to the optical axis. The first optical element, in the retracted state, is moved from an optical axis position on the optical axis to a first retraction position that differs from the optical axis position. The second optical element, in the retracted state, is moved from the optical axis position to a second retraction position that differs from the first retraction position. The first optical element and the second optical element, in the retracted state, are arranged such that an outer portion of the first optical element and of the second optical element are adjacent in a plane substantially orthogonal to the optical axis.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram depicting a configuration of the imaging apparatus of the first embodiment according to the present invention;

FIGS. 2, 3, 4, 5, 6, and 7 are diagrams depicting operation of the imaging apparatus according to the first embodiment of the present invention;

FIGS. 8, 9, 10, and 11 are diagrams depicting a configuration of a retractable lens barrel of a second embodiment; and

FIGS. 12, 13, and 14 depict operation of the retractable lens barrel of the second embodiment.

### DETAILED DESCRIPTION OF THE PREFERRED EMBODIMENTS

With reference to the accompanying drawings, a first embodiment of an imaging apparatus according to the invention will be described in detail.

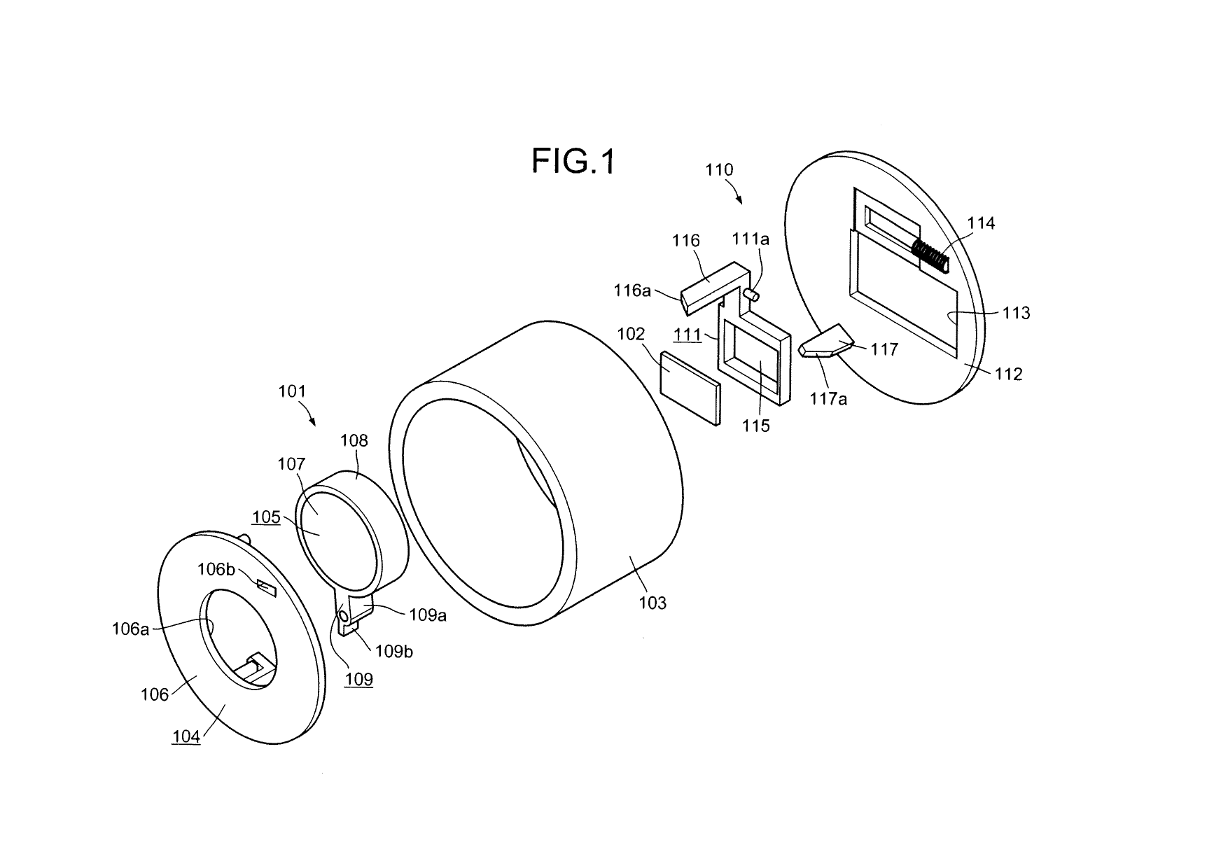

A configuration of an imaging apparatus of the first embodiment according to the present invention will be described. FIG. 1 is a diagram depicting a configuration of the imaging apparatus of the first embodiment according to the present invention. In FIG. 1, an exploded perspective view of a portion of the imaging apparatus is depicted.

In FIG. 1, the imaging apparatus of the first embodiment includes a retractable lens barrel 101 and an image sensor 102. The retractable lens barrel 101 includes a barrel member 103, a retracting base 104, and a retracting lens 105. The barrel member 103 has a circular cylindrical shape having a center at the optical axis. The retracting base 104 is within the barrel member 103 and is disposed farther on the object side than the retracting lens 105. The retracting base 104 can be moved relative to the barrel member 103, along a direction parallel to the optical axis.

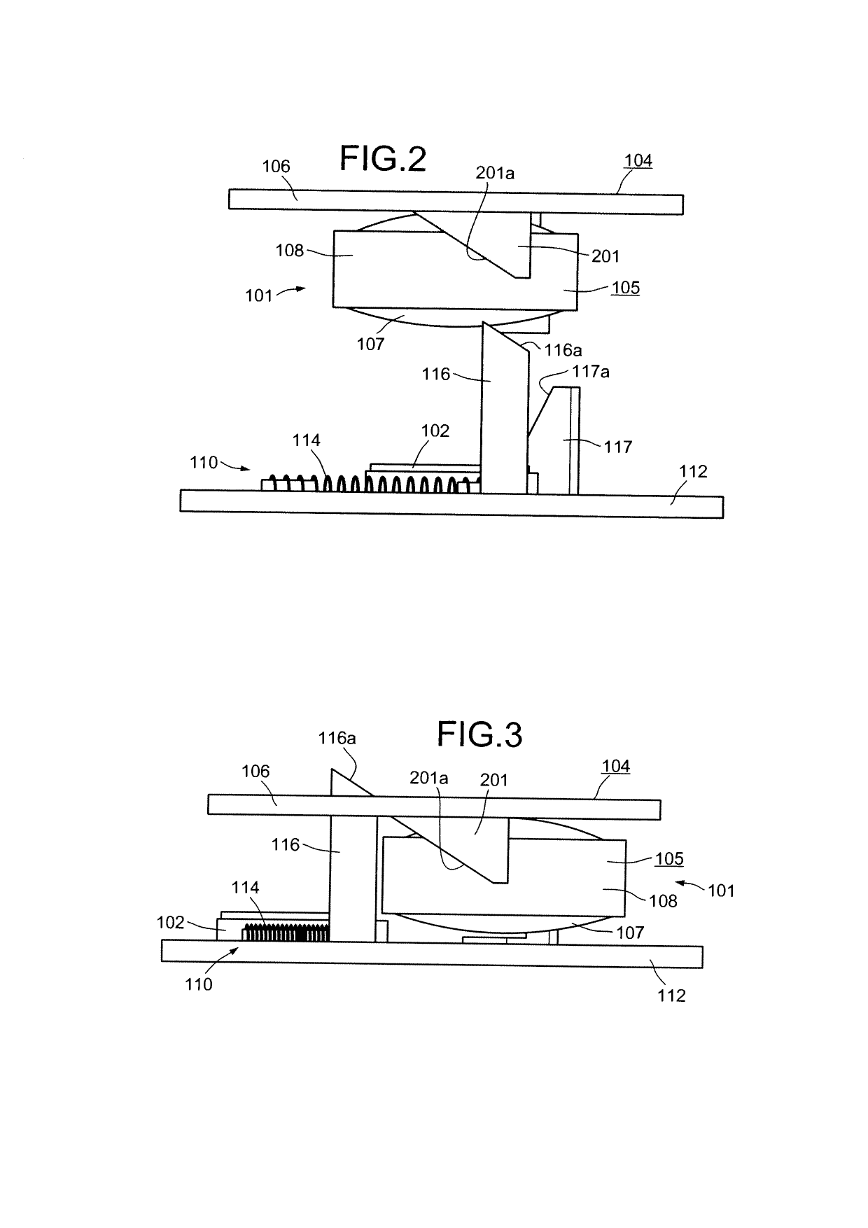

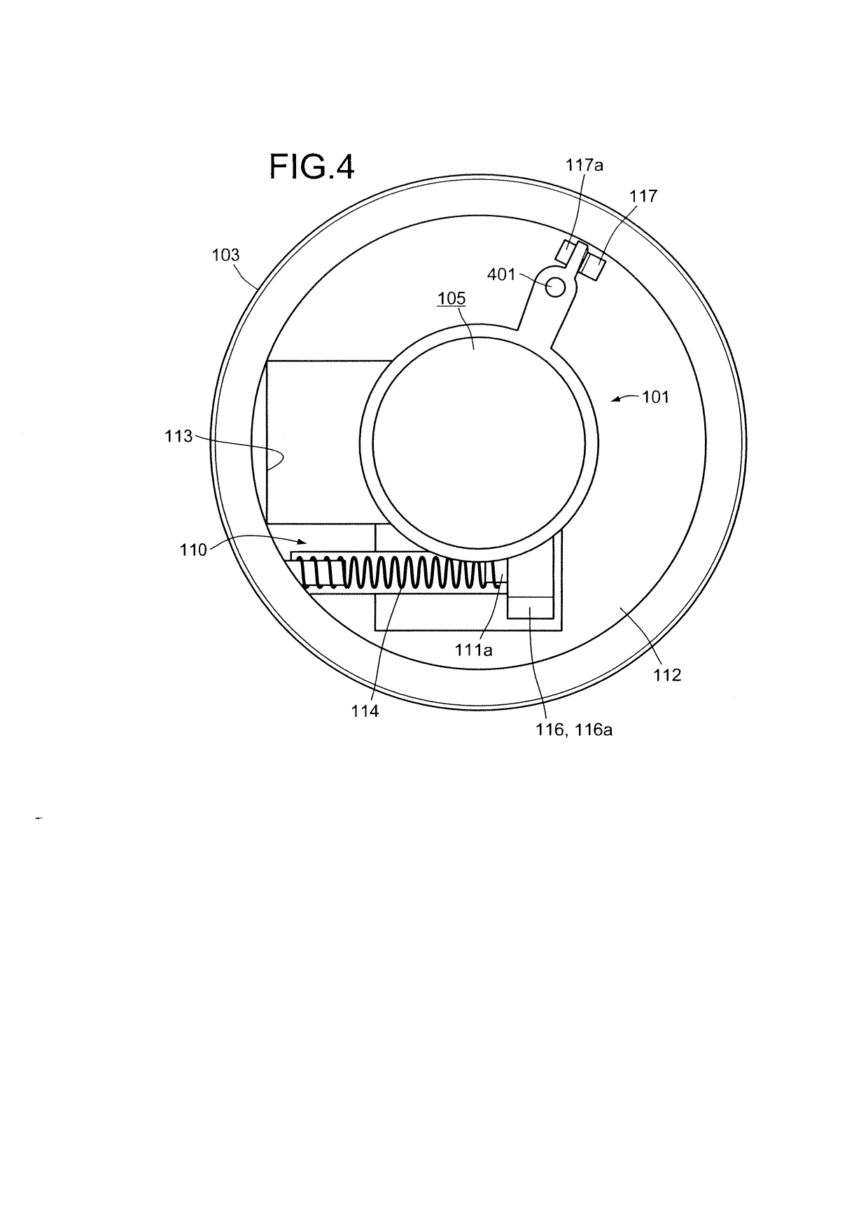

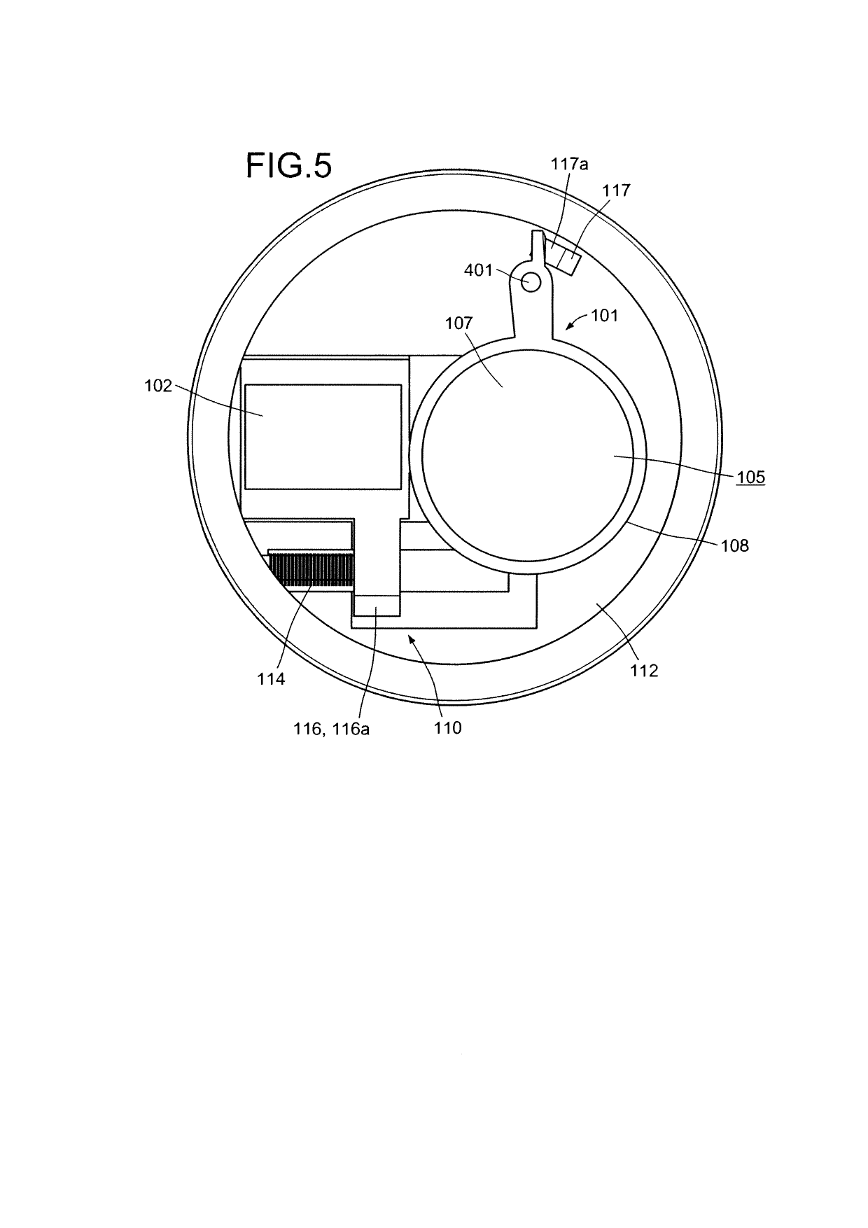

The retracting base 104 includes a base 106, a pivot (refer to reference numeral 401 in FIGS. 4 and 5), and a protrusion (refer to reference numeral 201 in FIGS. 2 and 3). The base 106 is a substantially circular plate having at a central portion, an opening 106a that is of a circular shape and has a center at the optical axis. The opening 106a passes through the base 106 along a direction parallel to the optical axis. The opening diameter of the opening 106a is a dimension approximately that of a diameter of a lens 107 in the retracting lens 105 or less. External light transmitted through the opening 106a from the object side is incident to the lens 107.

The protrusion of the retracting base 104 protrudes from the surface of the retracting base 104 facing toward the image sensor 102, in a direction toward the image sensor 102. A head (an end on the image sensor 102 side) of the protrusion of the retracting base 104 has a slanted surface (refer to reference numeral 201a in FIGS. 2 and 3) that is slanted with respect to a direction parallel to the optical axis and a plane orthogonal to the optical axis.

Further, the base 106 has, along a direction parallel to the optical axis, a through-hole 106b passing through the base 106. A support of the retracting base 104 protrudes from the surface of the retracting base 104 facing toward the image sensor 102, in a direction toward the image sensor 102. The support of the retracting base 104 supports the retracting lens 105.

The retracting lens 105 includes the lens 107 and a lens frame 108 that supports the peripheral edge of the lens 107. The lens 107 of the retracting lens 105 may be 1 or more lenses. In the first embodiment, among multiple optical elements, at least 1 optical element can be implemented by the retracting lens 105. The imaging apparatus may include a lens (lens group) in addition to the retracting lens 105. The lens frame 108 has a coupler 109 coupled with the support of the retracting base 104. The coupler 109 is coupled with the pivot so as to enable rotation centered about the support of the retracting base 104.

Thus, the lens frame 108, in a plane orthogonal to the optical axis, is able to move along an arc centered about the support of the retracting base 104. In the first embodiment, the retracting lens 105 can move between a position (hereinafter, “the optical axis position”) where the optical axis of the lens 107 in the retracting lens 105 is on the optical axis (the optical axis of the barrel member 103) of the retractable lens barrel 101 and a first retraction position that differs from the optical axis position. The imaging apparatus may include a biasing member (not depicted) that biases the lens frame 108 such that the retracting lens 105 is positioned at the optical axis position.

The coupler 109 includes a lens frame support 109a that extends from an coupling position for coupling with the retracting base 104 (pivot) toward an inner side (lens frame 108 side) of the barrel member 103 and a biased portion 109b that extends from the coupling position toward the peripheral side of the barrel member 103.

The image sensor 102 opto-electronically converts external incident light transmitted through the lens 107 of the retracting lens 105 and outputs an electronic signal corresponding to the intensity of the incident light. The image sensor 102, for example, can be implemented by a solid state image sensor such a charge coupled device (CCD) image sensor and a complementary metal oxide semiconductor (CMOS) image sensor.

The image sensor 102 is supported by an image sensor shifting mechanism 110. The image sensor shifting mechanism 110 includes an image sensor shifting member 111 and a support member 112. The support member 112 is a substantially circular plate having an opening 113 passing therethrough along a direction parallel to the optical axis. The image sensor shifting member 111 is in the opening 113 of the support member 112 and can be moved within a plane orthogonal to the optical axis, along a direction orthogonal to the optical axis.

The image sensor shifting member 111 can be moved between a first position positioning the image sensor 102 at a position (hereinafter, “optical axis position”) on the optical axis and a second position positioning the image sensor 102 at a given position different from the first position. In the first embodiment, the position of the image sensor 102 when the image sensor shifting member 111 is positioned at the second position is regarded as a second retraction position. The first retraction position and the second retraction position are different positions within a plane orthogonal to the optical axis.

The image sensor shifting mechanism 110 includes an image sensor biasing spring 114 that is a biasing member biasing the image sensor shifting member 111 from the second position toward the first position such that the image sensor 102 is positioned at the first position. The image sensor biasing spring 114 can be implemented by, for example, an elastic member that when an external force is applied to the image sensor biasing spring 114, the image sensor biasing spring 114 is compressed by the external force, and when the external force is removed, the image sensor biasing spring 114 is restored to the original shape.

For example, the image sensor biasing spring 114 can be implemented by a compression spring (compression coil spring). In this case, one end of the compression spring is fixed to the image sensor shifting member 111 and the other end of the compression spring is fixed to or abuts the image sensor 102. In the first embodiment, the latter end of the compression spring is latched to a projection 111a disposed on the image sensor shifting member 111.

The image sensor shifting member 111 includes a retainer 115 that holds the image sensor 102 and a protrusion 116 that protrudes toward the retracting base 104 from an aspect of the retainer 115 facing toward the object side. The retainer 115 includes an opening into which the image sensor 102 is fitted. The protrusion 116 has, at the head (the end on the retracting base 104 side), a slanted surface 116a that is slanted with respect to a direction parallel to the optical axis and a plane orthogonal to the optical axis.

The slanted surface 116a forming the head of the protrusion 116 is slanted at the same angle as the head of the protrusion of the retracting base 104. When the retracting base 104 is moved toward the support member 112, the head of the protrusion 116 is fitted into the through-hole 106b of the retracting base 104. Consequently, when the retracting base 104 is moved toward the support member 112, the protrusion 116 is prevented from interfering with the retracting base 104 and the retracting base 104 can be moved to a position yet closer to the support member 112.

The support member 112 has a protrusion 117 that protrudes toward the retracting base 104 from an aspect of the support member 112 facing toward the object side. The protrusion 117 is disposed in the same straight line parallel to the optical axis. The protrusion 117 has, at the head (the end on the retracting base 104), a slanted surface 117a that is slanted with respect to a direction parallel to the optical axis and a plane orthogonal to the optical axis. The slanted surface 117a of the protrusion 117 abuts the biased portion 109b when the retracting base 104 is moved toward the support member 112.

Operations of the imaging apparatus of the first embodiment will be described. FIGS. 2, 3, 4, 5, 6, and 7 are diagrams depicting operation of the imaging apparatus according to the first embodiment of the present invention.

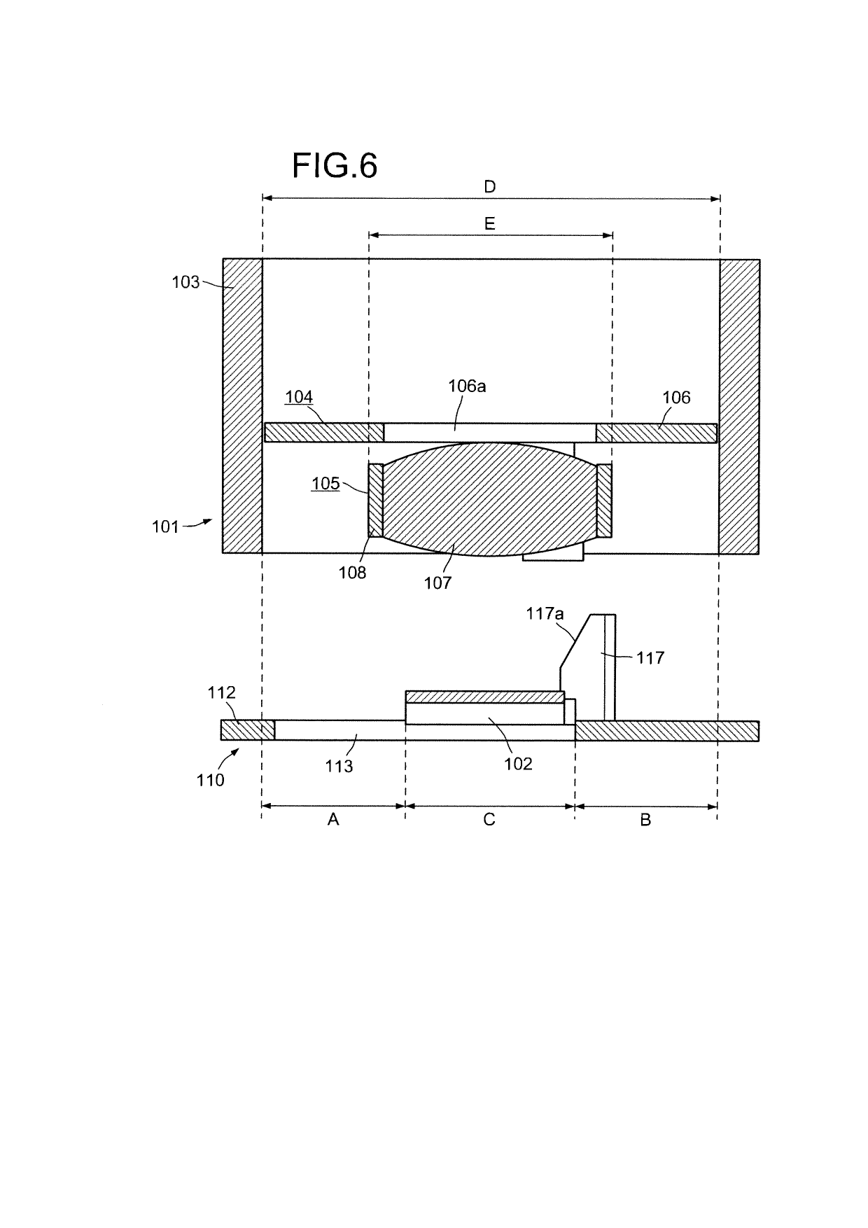

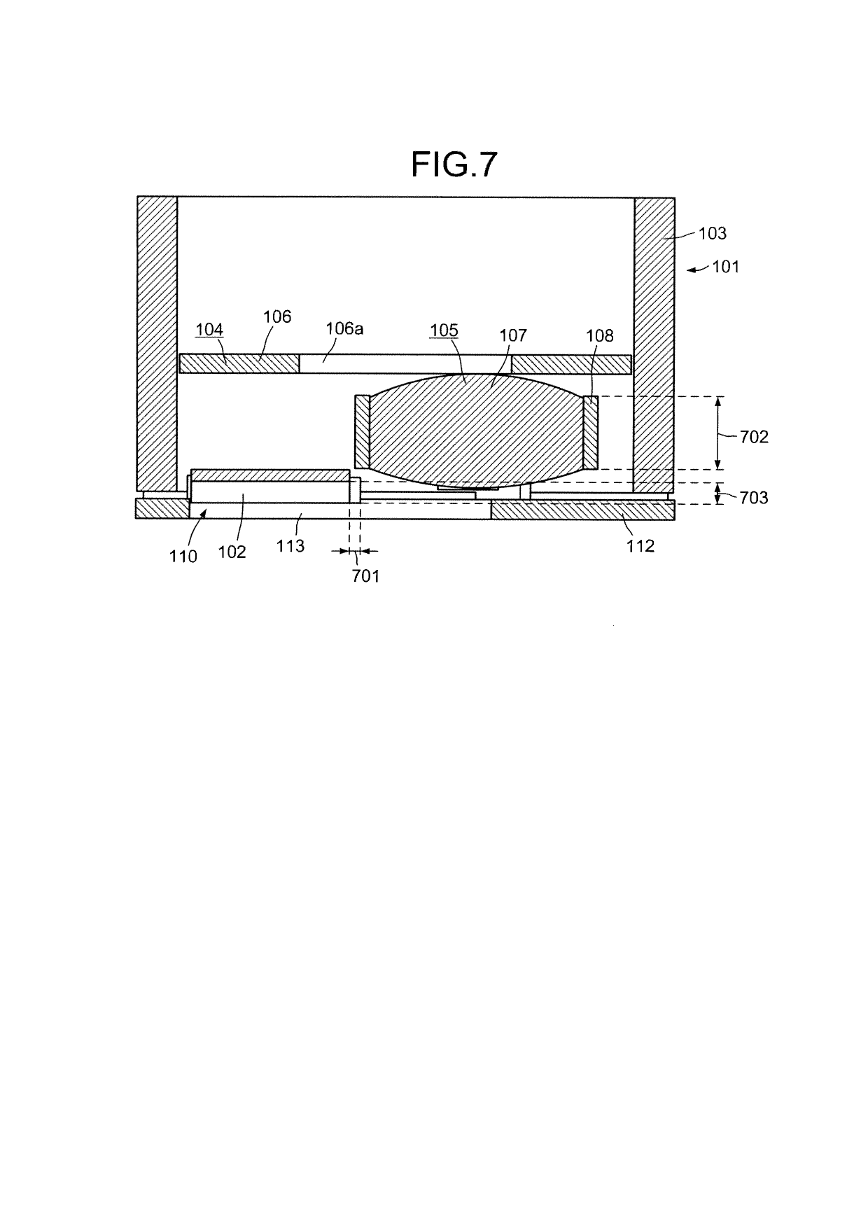

In FIGS. 2 and 3, a portion of the imaging apparatus according to the first embodiment of the present invention is depicted with the barrel member 103 being removed and as viewed from a direction orthogonal to the optical axis. In FIGS. 4 and 5, a portion of the imaging apparatus according to the first embodiment of the present invention is depicted as viewed from the object side, along a direction parallel to the optical axis. In FIGS. 6 and 7, a cross-section of a portion of the imaging apparatus according to the first embodiment of the present invention, taken along a plane parallel to the optical axis, is depicted.

In FIGS. 2, 3, 4, 5, 6, and 7, the imaging apparatus according to the first embodiment of the present invention assumes a configuration for times when the imaging apparatus is used such as when imaging is performed (utilization state) and a configuration for times when the imaging apparatus is not used such as when imaging is not performed (retracted state). FIGS. 2, 4, and 6 depict a portion of the imaging apparatus in a utilization state. FIGS. 3, 5, and 7 depict the imaging apparatus in a retracted state.

In the utilization state, the retracting lens 105 and the image sensor 102 are positioned at the optical axis position. Thus, in the utilization state, external light transmitted by the lens 107 of the retracting lens 105 is incident to the image sensor 102. In FIG. 6, reference character D indicates the inner diameter of the retractable lens barrel 101, and reference character C indicates the diameter of the image sensor 102. Further, in FIG. 6, reference character E indicates the outer diameter of the lens frame 108 (outer diameter of the retracting lens 105), exclusive of the coupler 109.

Reference character A in FIG. 6, indicates a dimension from an outer surface of image sensor 102 to an inner surface of the retractable lens barrel 101, in a cross-section of the imaging apparatus in the utilization state and taken along a plane parallel to the optical axis. The dimension indicated by reference character A indicates the distance that the image sensor 102 can be moved. Reference character B in FIG. 6 indicates a dimension from an outer surface of the image sensor 102 to an inner surface of the retractable lens barrel 101, in a cross-section of the imaging apparatus in the utilization state and taken along a plane parallel to the optical axis.

The dimensions D, C, E, A, and B in a cross-section of the imaging apparatus in the utilization state, taken along a plane parallel to the optical axis satisfy expressions (5), (6), (7), and (8).

A+B+C=D (5)

E+C≦D (6)

E>A (7)

E>B (8)

During transition from the utilization state to the retracted state, the retracting base 104 moves relatively toward the image sensor shifting member 111, along a direction parallel to the optical axis. When the retracting base 104 moves toward the image sensor shifting member 111, the slanted surface 117a of the protrusion 117 disposed on the support member 112 abuts, from the image side, the biased portion 109b disposed on the lens frame 108 of the retracting lens 105.

With the slanted surface 117a of the protrusion 117 abutting the biased portion 109b from the image side, the retracting base 104 moves farther toward the image sensor shifting member 111, whereby the biased portion 109b is pushed by the protrusion 117 and as the biased portion 109b shifts the abutting position of the protrusion 117, the retracting base 104 moves yet farther toward the image sensor shifting member 111. Consequently, the coupler 109 rotates centered about the support 401.

Consequent to the coupler 109 rotating about the support 401, the lens frame support 109a forming a portion of the coupler 109 rotates, and within a plane orthogonal to the optical axis, the lens frame 108 moves along an arc centered about the support 401. Consequently, in a state where the retracting base 104 has moved to the end on the image sensor shifting member 111 side along a direction parallel to the optical axis, i.e., the retracted state, the retracting lens 105 is positioned at the first retraction position.

The interval, along a direction parallel to the optical axis, between the retracting base 104 and the support member 112 in the retracted state is equivalent to a dimension of the retracting lens 105, along the optical axis, or is slightly greater than the dimension. Consequently, the retracting lens 105 positioned at the first retraction position can prevent damage to the retracting lens 105 (the lens 107, the lens frame 108, etc.) caused by contact with surrounding members.

Further, when the retracting base 104 moves toward the image sensor shifting member 111, the slanted surface 201a of the head of the protrusion 201 disposed on the retracting base 104 abuts the slanted surface 116a of the head of the protrusion 116 disposed on the image sensor shifting member 111. With the slanted surface 201a of the head of the protrusion 201 abutting the slanted surface 116a of the head of the protrusion 116, the retracting base 104 moves farther toward the image sensor shifting member 111, whereby the protrusion 116 is pushed by the protrusion 201 and as the protrusion 116 shifts the abutting position at the slanted surfaces 201a, 116a, the protrusion 116 moves in a direction depicted as a leftward direction in 2.

The image sensor shifting member 111, together with the movement of the protrusion 116 in the leftward direction depicted in FIG. 2, compresses the image sensor biasing spring 114 while moving in the leftward direction depicted in FIG. 2. In a state where the retracting base 104 has moved to the end on the image sensor shifting member 111 side along a direction parallel to the optical axis, i.e., the retracted state, the image sensor shifting member 111 is positioned at the second position. In a state where the image sensor shifting member 111 is positioned at the second position, i.e., the retracted state, the image sensor 102 is positioned at the second retraction position.

When the imaging apparatus of the first embodiment is in the retracted state in which the retracting lens 105 is moved to the first retraction position and the image sensor 102 is moved to the second retraction position, the retracting lens 105 and the image sensor 102 are arranged such that at least 1 portion of the retracting lens 105 and of the image sensor 102 overlap in a plane that is substantially orthogonal to the optical axis (refer to reference character 701 in FIG. 7). When the imaging apparatus of the first embodiment is in the retracted state, the retracting lens 105 and the image sensor 102 are arranged such that respective edges (at the greatest dimension in a plane substantially orthogonal to the optical axis) of the retracting lens 105 and of the image sensor 102 are at different positions along a direction parallel to the optical axis (refer to reference character 702 and reference character 703 in FIG. 7).

In this manner, since the first retraction position and the second retraction position differ in a plane orthogonal to the optical axis and expression (6) E+C≦D is satisfied, interference between the retracting lens 105 and the image sensor 102 in the retracted state can be suppressed. As a result, damage of the retracting lens 105 and/or the image sensor 102 consequent to contact between the retracting lens 105 and the image sensor 102 can be prevented.

Since the retracting lens 105 and the image sensor 102 are arranged such that the respective edges (at the greatest dimension in a plane substantially orthogonal to the optical axis) of the retracting lens 105 and of the image sensor 102 are at different positions along a direction parallel to the optical axis (refer to reference character 702 and reference character 703 in FIG. 7), the retracting lens 105 and the image sensor 102 can be arranged such that at least 1 portion of the retracting lens 105 and of the image sensor 102 overlap in a plane substantially orthogonal to the optical axis. Consequently, even when the relation of the dimension C (the diameter of the image sensor 102) and dimension E (an outer dimension of the retracting lens 105 (the lens frame 108)) satisfies expression (6) E+C=D, interference between the lens 107 and the image sensor 102 in the retracted state can be assuredly prevented.

Further, as described, since dimensions D, C, E, A, and B satisfy expressions (5), (6), (7), and (8), damage of the lens 107 consequent to the lens 107 and the image sensor 102 contacting surrounding members, in the retracted state, can prevented.

As described, in the imaging apparatus of the first embodiment according to the present invention, the image sensor 102 and the optical elements included in the retracting lens 105 are arranged on the optical axis in the utilization state, and in the retracted state, arrangement is such that the retracting lens 105 is moved to the first retraction position while the image sensor 102 is moved to the second retraction position and in a plane substantially orthogonal to the optical axis, at least 1 portion of the retracting lens 105 and of the image sensor 102 overlap.

Further, the imaging apparatus of the first embodiment according to the present invention, in the utilization state satisfies conditional expressions (5) to (8), where in a cross-section along a plane parallel to the optical axis, dimension D is the inner diameter of the retractable lens barrel 101, dimension C is the diameter of the image sensor 102, dimension E is the outer diameter of the retracting lens 105, dimension A is the dimension from an outer surface of the image sensor 102 to an inner surface of the retractable lens barrel 101, and dimension B is the dimension from the other outer surface of the image sensor 102 to the inner surface of the retractable lens barrel 101.

According to the imaging apparatus of the first embodiment, in the retracted state, the retracting lens 105 and the image sensor 102 are each moved to the first retraction position and the second retraction position respectively different from the optical axis position, whereby a plane substantially orthogonal to the optical axis, the retracting lens 105 and the image sensor 102 can be arranged to appose one another. As a result, in the retracted state, the dimension of the imaging apparatus along a direction parallel to the optical axis can be reduced compared to a conventional imaging apparatus in which the retracting lens 105 and the image sensor 102 can move only along a direction parallel to the optical axis.

Further, according to the imaging apparatus of the first embodiment, in retracted state, at least 1 portion of the retracting lens 105 and of the image sensor 102 overlap in a plane substantially orthogonal to the optical axis, whereby compared to a case where in the retracted state, the retracting lens 105 and the image sensor 102 are arranged adjacently in a plane substantially orthogonal to the optical axis, the dimension of the imaging apparatus along a direction parallel to the optical axis can be reduced, without an increase in the outer diameter of the retractable lens barrel 101.

In this manner, the imaging apparatus of the first embodiment enables the dimension of the imaging apparatus along a direction parallel to the optical axis to be reduced, without an increase in the outer diameter of the retractable lens barrel 101 and thereby, enables an imaging apparatus to be provided that achieves a reduction in the size of the imaging apparatus when not in use and further enables a greater degree of freedom in the design of the optical elements or the image sensor.

The imaging apparatus of the first embodiment, when transitioning from the utilization state to retracted state or from the retracted state to the utilization state, can move the retracting lens 105 between the optical axis position and the first retraction position and can move the image sensor 102 between the optical axis position and the second retraction position, without the use of a motive force such as by a motor, thereby enabling power consumption of the imaging apparatus to be suppressed.

In particular, among imaging apparatuses of which a small size is demanded such as compact cameras, consequent to the overall smaller size of the imaging apparatus, the drive source such as a battery disposed in the imaging apparatus has to be small. When the drive source such as the battery is of a small size, for the same type of battery, the capacity thereof also tends to be smaller. However, the imaging apparatus of the first embodiment enables the power consumption of the imaging apparatus to be suppressed and thereby, enables the time that the imaging apparatus can be used to be extended.

A configuration of the retractable lens barrel of a second embodiment will be described. Components identical to those of the first embodiment are given the same reference characters used in the first embodiment and description thereof is omitted.

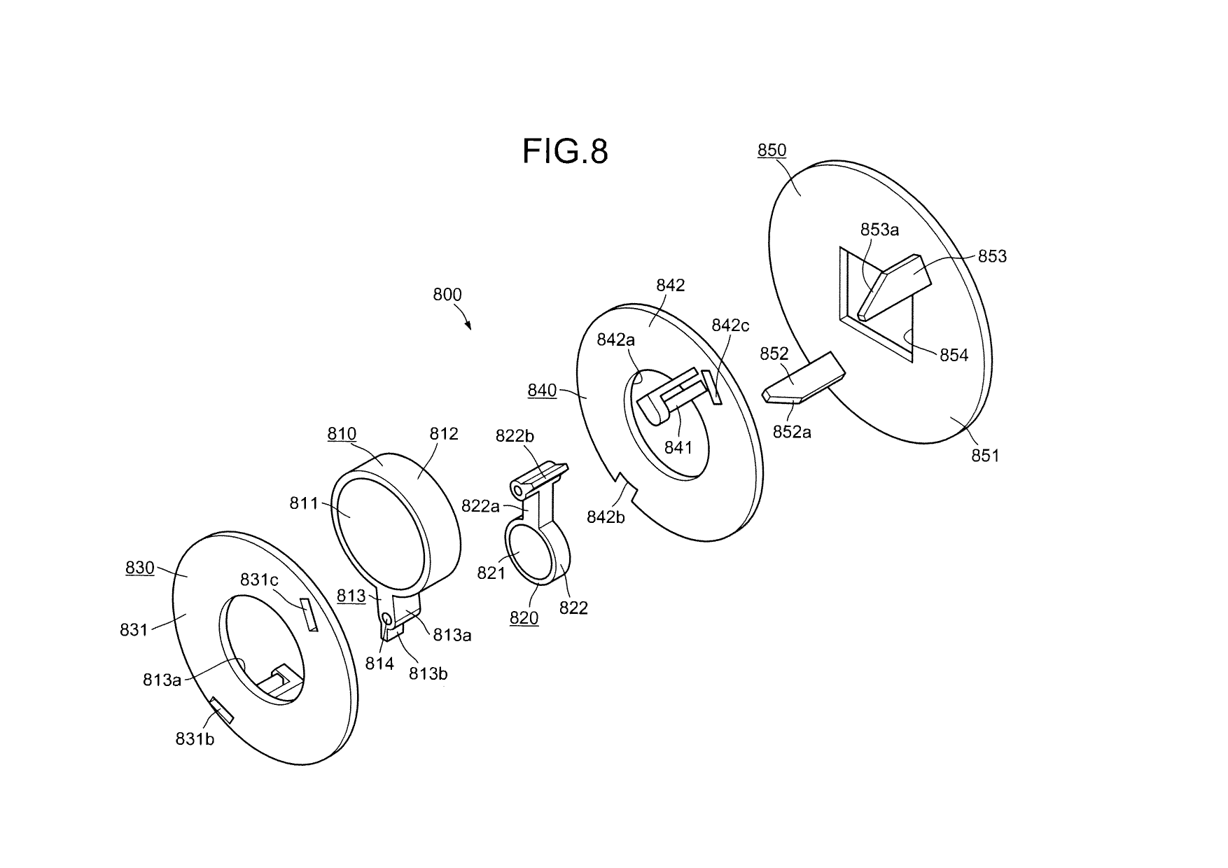

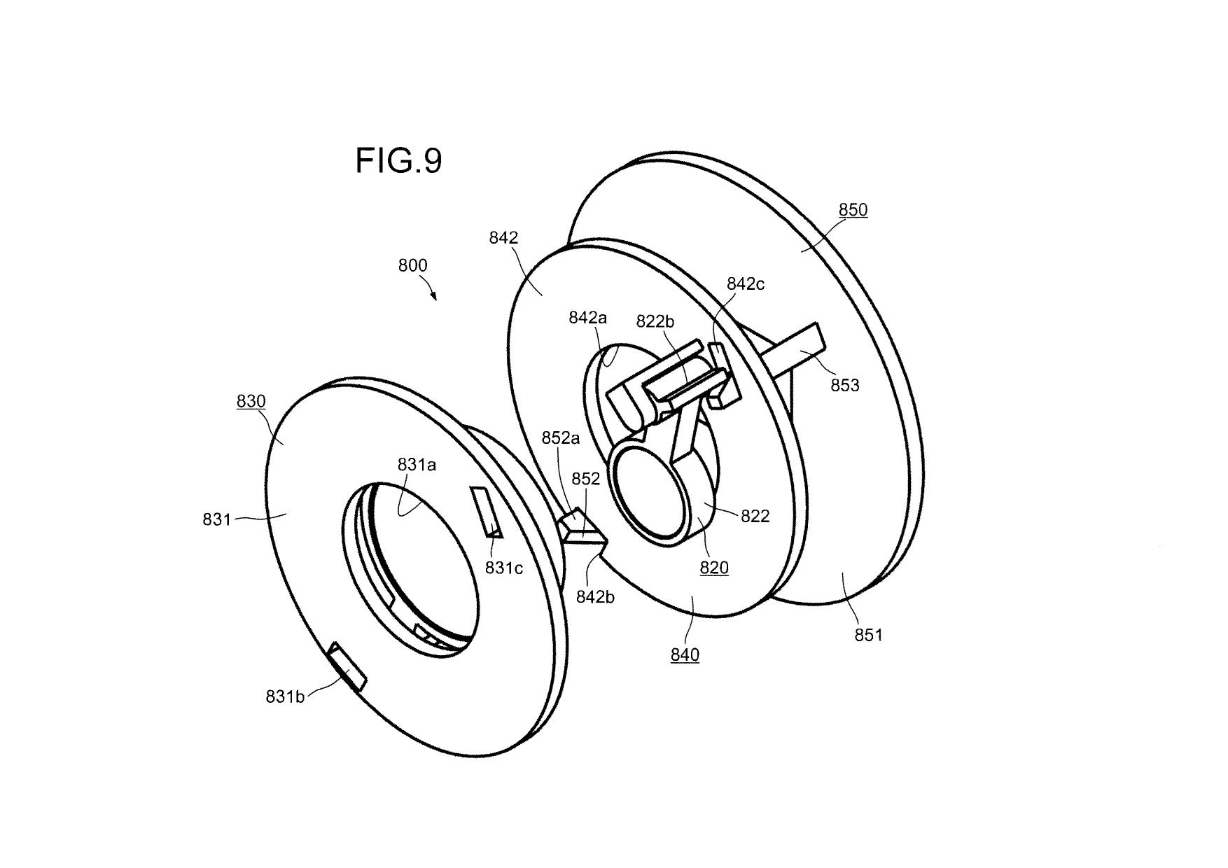

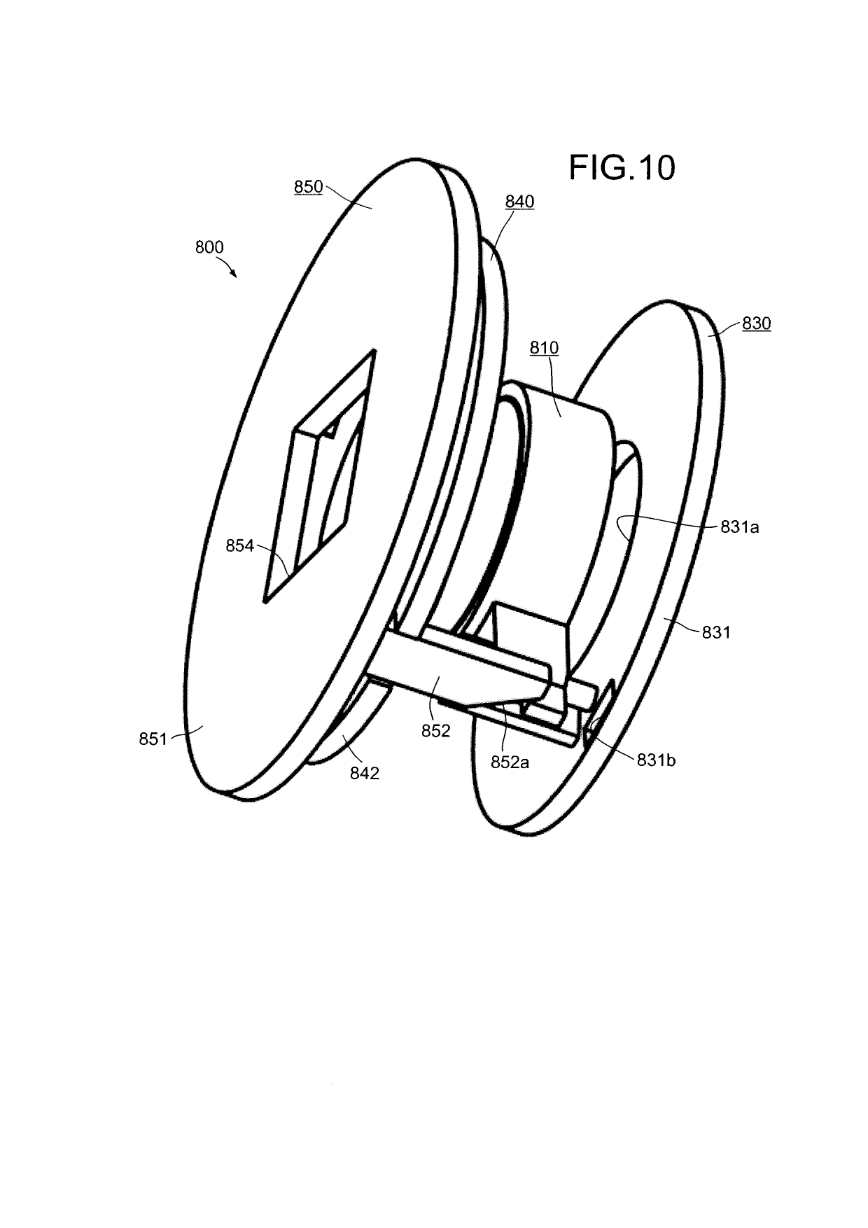

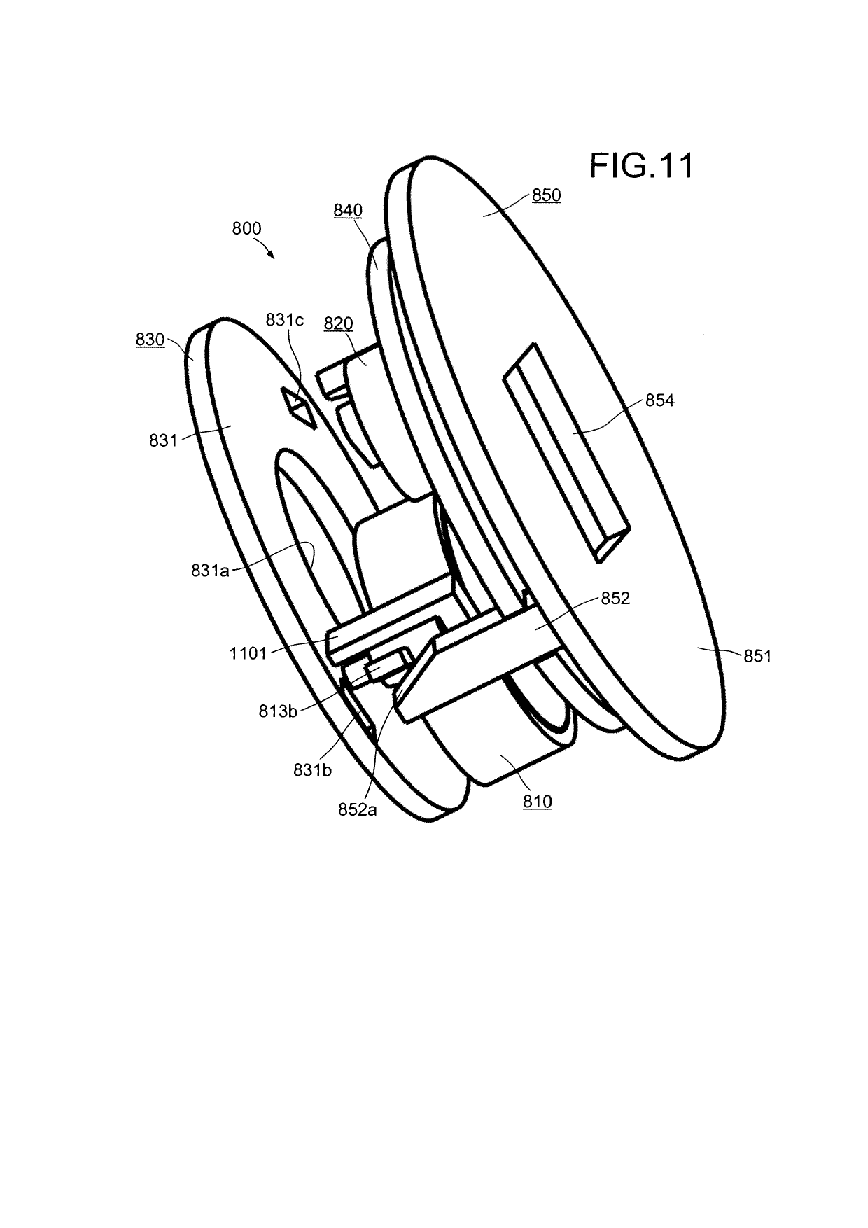

FIGS. 8, 9, 10, and 11 are diagrams depicting a configuration of the retractable lens barrel of the second embodiment. In FIG. 8, an exploded perspective view of the retractable lens barrel of the second embodiment is depicted. FIGS. 9, 10, and 11 depict perspective views of the retractable lens barrel of the second embodiment, from different angles.

In FIGS. 8, 9, 10, and 11, a retractable lens barrel 800 of the second embodiment is configured by lens groups 810 and 820, and retracting bases 830, 840, and 850. The lens group 810 is configured by a lens 811 and a lens frame 812 that holds a peripheral edge of the lens 811. The lens 811 may be disposed singularly or in plural. In the second embodiment, first optical elements are implemented by the lens group 810.

The lens frame 812 includes a coupler 813 that has a lens frame support 813a and a biased portion 813b. The lens group 810 is formed by the same configuration as the retracting lens 105 disposed in the imaging apparatus of the first embodiment. The lens frame 812 can move along an arc centered about a coupling position 814 where coupling with a pivot (not depicted) disposed on the retracting base 830 occurs.

Thus, the lens group 810, in a plane orthogonal to the optical axis, can move along an arc centered about the coupling position 814. In the second embodiment, the optical axis of the lens 811 in the lens group 810 can be moved between the optical axis position in the retractable lens barrel 800 and the first retraction position, which differs from the optical axis position.

The lens group 820 is configured by a lens 821 and a lens frame 822 that holds a peripheral edge of the lens 821. The lens 821 may be disposed singularly or in plural. In the second embodiment, second optical elements can be implemented by the lens group 820. A dimension of the lens group 820 along a direction parallel to the optical axis is smaller than a dimension of the lens group 810 along a direction parallel to the optical axis.

The lens frame 822 includes a lens frame support 822a and is coupled through the lens frame support 822a, to a pivot 841 disposed on the retracting base 840. At the head of the lens frame support 822a, a biased portion 822b is disposed. The pivot 841 disposed on the retracting base 840, protrudes along a direction parallel to the optical axis, from a surface of the retracting base 840 on the lens group 820 side toward the lens group 820. The lens frame 822 is coupled to the pivot 841, enabling rotation centered about the pivot 841.

Thus, the lens group 820 can move along an arc centered about the pivot 841, in a plane orthogonal to the optical axis. In the second embodiment, the optical axis of the lens 821 in the lens group 820 can move between the optical axis position in the retractable lens barrel 800 and the second retraction position, which differs from the optical axis position. The second retraction position is a position that, in a plane orthogonal to the optical axis, differs from the first retraction position, and that in the retracted state, is a position in the same plane orthogonal to the optical axis.

The retracting base 830 has the same configuration as the retracting base 104 of the imaging apparatus according to the first embodiment and includes a support 1101 and a base 831 having an opening 831a, a recess 831b and a through-hole 831c. At the coupling position 814, the support 1101 is coupled to the lens frame 812. The recess 831b allows for an insertion of a protrusion 852 provided on the retracting base 850. A protrusion 853 provided on the retracting base 850 passes through the through-hole 831c.

In addition to the pivot 841, the retracting base 840 is further formed by a base 842 having an opening 842a that is circular and centered about the optical axis. The base 842 includes a recess 842b that allows for an insertion of the protrusion 852 of the retracting base 850 and a through-hole 842c through which the protrusion 853 of the retracting base 850 passes.

The retracting base 850 includes a base 851, the protrusion 852, the protrusion 853, and an opening 854. The protrusion 852 protrudes from the surface of the base 851 facing toward the retracting base 840, in a direction along a direction parallel to the optical axis toward the retracting base 840. The head (the end on the retracting base 840 side) of the protrusion 852 has a slanted surface 852a that is slanted with respect to a direction parallel to the optical axis and a plane orthogonal to the optical axis.

The protrusion 853 protrudes from the side of the base 851 facing toward the retracting base 840, in a direction parallel to the optical axis toward the retracting base 840. The head (the end on the retracting base 840 side) of the protrusion 853 has a slanted surface 853a that is slanted with respect to a direction parallel to the optical axis and a plane orthogonal to the optical axis. The opening 854 has a substantially square-shape centered about the optical axis and passes through the base 851 along a direction parallel to the optical axis.

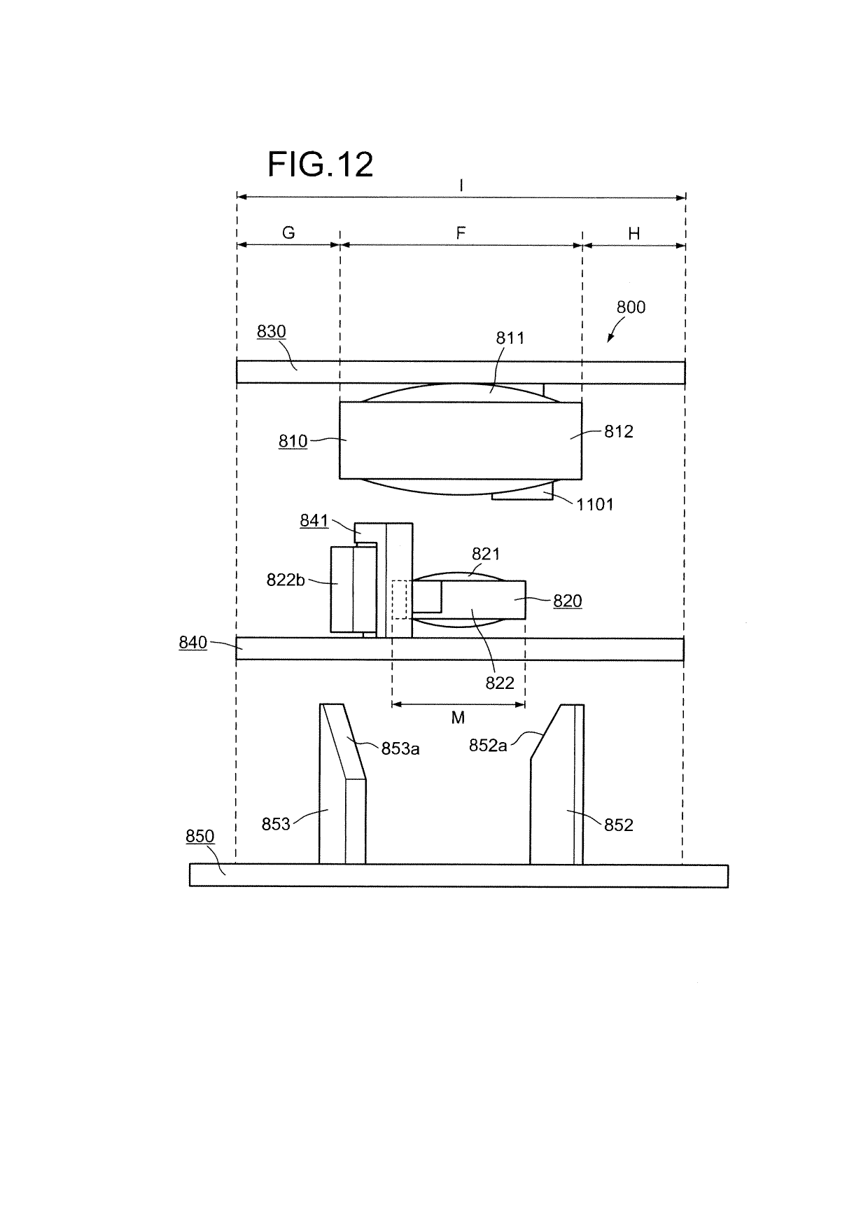

Operation of the retractable lens barrel 800 of the second embodiment will be described. FIGS. 12, 13, and 14 depict operation of the retractable lens barrel 800 of the second embodiment.

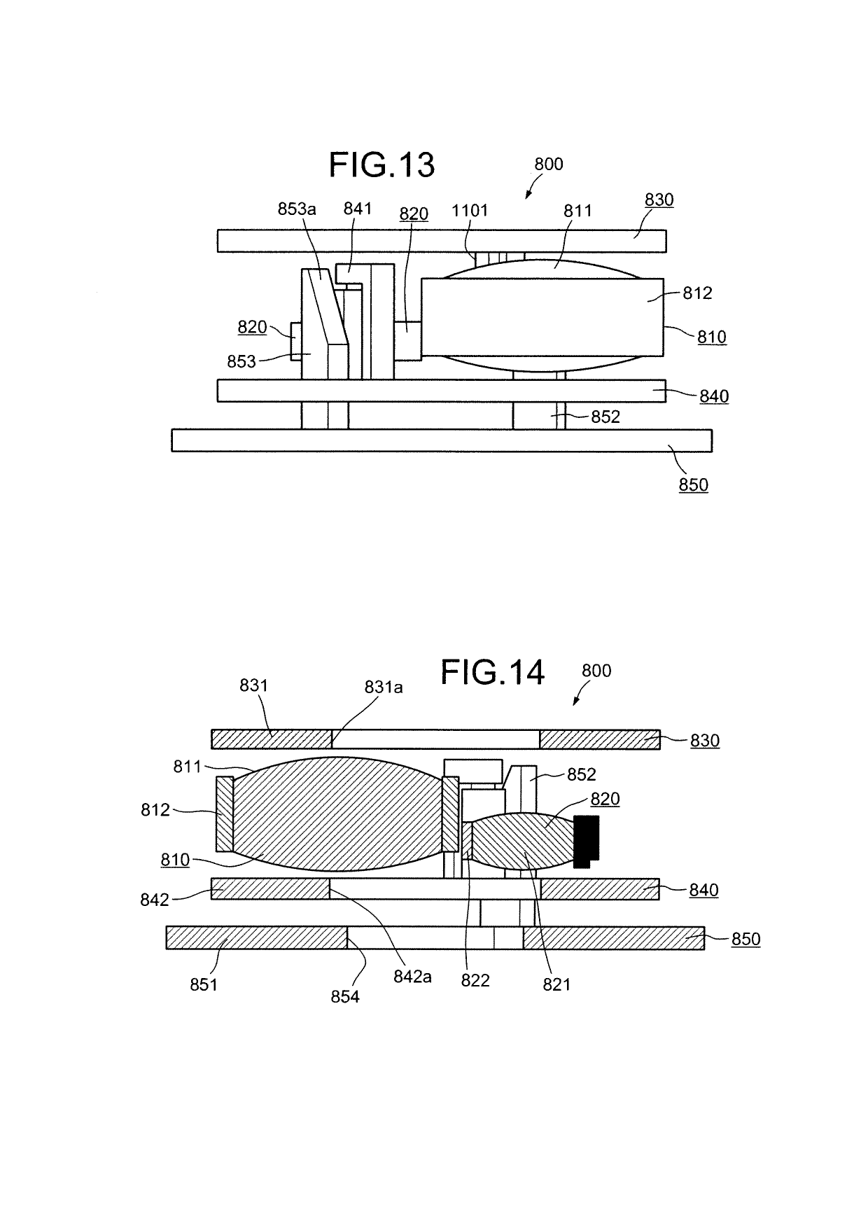

In FIGS. 12 and 13, the retractable lens barrel 800 is depicted as viewed from a direction orthogonal to the optical axis. In FIG. 14, a cross-section of the retractable lens barrel 800, taken along a plane parallel to the optical axis.

In FIGS. 12, 13, and FIG. 14, the retractable lens barrel 800 of the second embodiment assumes a configuration for times when the retractable lens barrel 800 is used (utilization state) and a configuration for times when the retractable lens barrel 800 is not used (retracted state). FIG. 12 depicts the retractable lens barrel 800 in the utilization state. FIGS. 13 and 14 depict a portion of the retractable lens barrel 800 in the retracted state.

In the utilization state, the lens groups 810 and 820 are positioned at the optical axis position. Thus, in the utilization state, external light transmitted by the lens groups 810 and 820 is incident to the non-depicted image sensor. In FIG. 12, reference character I indicates the diameter of the retracting base 830. The lens groups 810 and 820 can move in a plane orthogonal to the optical axis, within the range prescribed by dimension I (the diameter of the retracting base 830).

In FIG. 12, reference character F indicates the diameter of the lens group 810 and reference character M indicates the diameter of the lens group 820. In FIG. 12, reference character G indicates a dimension from an outer surface of the lens group 810 to an end of the range prescribed by dimension I (the diameter of the retracting base 830) in a cross-section of the retractable lens barrel 800 in the utilization state, taken along a plane parallel to the optical axis. In FIG. 12, reference character H indicates a dimension from the outer surface of the lens group 810 to the other end of the range prescribed by dimension I (the diameter of the retracting base 830) in a cross-section of the retractable lens barrel 800 in the utilization state, taken along a plane parallel to the optical axis.

Dimensions I, F, M, G, and H in a cross-section of the retractable lens barrel 800 in the utilization state, taken along a plane parallel to the optical axis satisfy expressions (1), (2), (3), and (4).

F+G+H=I (1)

F+M≦l (2)

M>G (3)

M>H (4)

During transition from the utilization state to retracted state, the retracting base 830 moves relatively toward the retracting base 850, along a direction parallel to the optical axis. When the retracting base 830 moves toward the retracting base 850, the slanted surface 852a of the protrusion 852 disposed on the retracting base 850 abuts the biased portion 813b disposed on the lens frame 812 of the lens group 810 from the image plane side.

With the slanted surface 852a of the protrusion 852 abutting the biased portion 813b from the image plane side, the retracting base 830 moves farther toward the retracting base 850, whereby the biased portion 813b is pushed by the protrusion 852 and as the slanted surface 852a of the protrusion 852 shifts the abutting position, the retracting base 830 moves yet farther toward the retracting base 850. Consequently, the coupler 813 rotates centered about the coupling position 814.

Consequent to the coupler 813 rotating about the coupling position 814, the lens frame support 813a forming a portion of the coupler 813 rotates, and within a plane orthogonal to the optical axis, the lens frame 812 moves along an arc centered about the coupling position 814. Consequently, in a state where the retracting base 830 has moved to the end on the retracting base 850 side along a direction parallel to the optical axis, i.e., the retracted state, the lens group 810 is positioned at the first retraction position.

The interval, along a direction parallel to the optical axis, between the retracting base 830 and the retracting base 840 in the retracted state is equivalent to a dimension of the lens group 810, along the optical axis, or is slightly greater than the dimension. Consequently, the lens group 810 positioned at the first retraction position can prevent damage to the retracting lens group 810 (the lens 811 and the lens frame 812, etc.) caused by contact with surrounding members.

Further, when the retracting base 830 moves toward the retracting base 850, the slanted surface 853a of the head of the protrusion 853 disposed on the retracting base 850 abuts the biased portion 822b of the head of the lens frame 822 from the image plane side. With the slanted surface 853a of the protrusion 853 abutting the biased portion 822b from the image side, the retracting base 830 moves farther toward the retracting base 850, whereby the biased portion 822b is pushed by the protrusion 853 and as the protrusion 853 shifts the abutting position at the slanted surface 853a, the retracting base 830 moves yet farther toward the retracting base 850. Consequently, the lens frame support 822a rotates about the pivot 841.

Consequent to the lens frame support 822a rotating about the pivot 841, in a plane orthogonal to the optical axis, the lens frame 822 moves along an arc centered about the pivot 841. As a result, in state where the retracting base 830 has moved to the end on the retracting base 850 side along a direction parallel to the optical axis, i.e., the retracted state, the lens group 820 is positioned at the second retraction position.

The interval, along a direction parallel to the optical axis, between the retracting base 830 and the retracting base 840 in the retracted state is equivalent to a dimension of the lens group 810, along the optical axis, or is slightly greater than the dimension; and a dimension of the lens group 820, along the optical axis, is smaller than a dimension of the lens group 810, along the optical axis. Consequently, the lens group 820 positioned at the second retraction position can prevent damage of the retracting lens group 820 (the lens 821 and the lens frame 822, etc.) consequent to contact with surrounding members.

When the retractable lens barrel 800 of the second embodiment is in the retracted state where the lens group 810 transitions to the first retraction position and the lens group 820 transitions to second retraction position, the lens groups 810 and 820 are arranged such that an outer portion of the lens group 810 and of the lens group 820 are adjacent (refer to FIG. 13).

As described, the first retraction position and the second retraction position are different in a plane orthogonal to the optical axis and satisfy expression (2) F+M≦l, whereby the interference of the lens group 810 and the lens group 820 can be controlled in the retracted state. As a result, damage of the lens group 810 (the lens 811 and the lens frame 812) and of the lens group 820 (the lens 821 and the lens frame 822) consequent to contact of the lens group 810 and the lens group 820 can be prevented.

As described, the retractable lens barrel 800 of the second embodiment has multiple lens groups (the lens groups 810 and 820) disposed on the same optical axis, while in the retracted state, the lens group 810 is moved to the first retraction position and the lens group 820 is moved to the second retraction position such that an outer portion of the former and of the latter become adjacent to one another.

Further, in the retractable lens barrel 800 of the second embodiment, the inner diameter I of the retractable lens barrel 800, the outer diameter F of the lens group 810, the outer diameter M of the lens group 820, dimension G from the outer surface of the lens group 810 to an end of the range prescribed by dimension I (the diameter of the retracting base 830), and dimension H from the outer surface of the lens group 810 to the other end of the range prescribed by dimension I in a cross-section of the imaging apparatus in the utilization state taken along a plane parallel to the optical axis, satisfy expressions (1) to (4).

According to the retractable lens barrel 800 of the second embodiment, in the retracted state, the lens group 810 and the lens group 820 are respectively moved to the first retraction position and the second retraction position, which each differ from the optical axis position, whereby in a plane that is substantially orthogonal to the optical axis, the lens groups 810 and 820 can be arranged to appose one another. As a result, in the retracted state, the dimension of the retractable lens barrel 800 along a direction parallel to the optical axis can be reduced compared to a conventional imaging apparatus in which the lens groups 810 and 820 can move only along a direction parallel to the optical axis.

Further, according to the retractable lens barrel 800 of the second embodiment, in retracted state, the lens group 810 and the lens group 820 are arranged such that an outer portion of the lens group 810 and of the lens group 820 are adjacent, thereby enabling the dimension of the retractable lens barrel 800 along a direction parallel to the optical axis can be reduced in retracted state without an increase in the outer diameter of the retractable lens barrel 800.

In this manner, the retractable lens barrel 800 of the second embodiment enables the dimension of the retractable lens barrel 800 along a direction parallel to the optical axis to be reduced in retracted state without an increase in the outer diameter of the retractable lens barrel 800 and thereby, enables the retractable lens barrel 800 to be provided which enables size reductions in a state of non-use and improvement in the degree of freedom in the design of optical elements or the image sensor.

The retractable lens barrel 800 of the second embodiment enables power consumption to be suppressed by reducing the size in a state of non-use and therefore, even when the size an imaging apparatus equipped with the retractable lens barrel 800 is reduced, the time that the imaging apparatus can be used can be extended.

In the first embodiment, an example was described where among multiple optical elements, at least 1 optical element is implemented by the retracting lens 105. In the second embodiment, although first optical elements are implemented by the lens group 810 and second optical elements are implemented by the lens group 820 optical elements, configuration is not limited to these lenses. The optical elements, for example, in place of lens or in addition to lenses, may be implemented by an optical filter, a diaphragm, and a shutter.

As described, the retractable lens barrel and the rig apparatus according to the present invention are useful an imaging apparatus having a retractable lens barrel that is extended during use and retracted during non-use, and in the retractable lens barrel equipped on such an imaging apparatus. The retractable lens barrel and the imaging apparatus according to the present invention are particularly suitable for an imaging apparatus of which a compact size is demanded during non-use and a retractable lens barrel equipped on such an imaging apparatus.

The retractable lens barrel and imaging apparatus according to the invention facilitate a compact size during non-use and an improved degree of freedom in the design of optical elements or the image sensor.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2012-008536 filed in Japan on Jan. 18, 2012.

What is claimed:

1. A retractable lens barrel that comprises a plurality of optical elements, is extended in a utilization state, and retracted along a direction parallel to an optical axis in a retracted state, wherein
the optical elements, in the utilization state, are arranged adjacently on the same optical axis and include a first optical element and a second optical element that can be moved relative to one another along a direction parallel to the optical axis,
the first optical element in the retracted state, is moved from an optical axis position on the optical axis to a first retraction position that differs from the optical axis position,
the second optical element in the retracted state, is moved from the optical axis position to a second retraction position that differs from the first retraction position,
the first optical element and the second optical element in the retracted state are arranged such that an outer portion of the first optical element and of the second optical element are adjacent in a plane substantially orthogonal to the optical axis.

2. The retractable lens barrel according to claim 1, wherein in a cross-section of the retractable lens barrel, taken along a plane parallel to the optical axis in the utilization state,
I is an inner diameter of the retractable lens barrel,
F is an outer diameter of the first optical element,
M is an outer diameter of the second optical element,
G is a dimension from an outer surface the first optical element to an inner surface of the retractable lens barrel,
H is a dimension from another outer surface of the first optical element to the inner surface of the retractable lens barrel, and
I, F, M, G, and H are values satisfying conditions:
F+G+H=I (1)
F+M≦I (2)
M>G (3)
M>H. (4)

3. An imaging apparatus that comprises a plurality of optical elements, a retractable lens barrel that is extended in a utilization state and is retracted along a direction parallel to an optical axis in a retracted state, and an image sensor that captures images taken in by the optical elements, wherein
the optical elements and the image sensor, in the utilization state, are arranged on the same optical axis,
the optical elements in the retracted state, include at least one optical element that is moved from an optical axis position on the optical axis to a first retraction position that differs from the optical axis position,
the image sensor in the retracted state is moved from the optical axis position to a second retraction position that differs from the first retraction position, and
the moved optical element and the image sensor in the retracted state are arranged such that at least one portion of the move optical element and of the image sensor overlap in a plane substantially orthogonal to the optical axis.

4. The imaging apparatus according to claim 3, wherein in a cross-section of the imaging apparatus, taken along a plane parallel to the optical axis in the utilization state,
D is an inner diameter of the retractable lens barrel,
C is a diameter of the image sensor,
E is an outer diameter of the moved optical element,
A is a dimension from an outer surface of the image sensor to an inner surface of the retractable lens barrel,
B is a dimension from another outer surface of the image sensor to the inner surface of the retractable lens barrel, and
D, C, E, A, and B are values satisfying conditions:
A+B+C=D (5)
E+C≦D (6)
E>A (7)
E>B. (8)
